(19) United States
(12) Patent Application Publication
(10) Pub. No.: US 2016/0371725 A1
(43) Pub. Date: Dec. 22, 2016

(54) CAMPAIGN OPTIMIZATION SYSTEM

(71) Applicants: Duy Nguyen, Bristow, VA (US); Vu Huy Tran, Ho Chi Minh City (VN)

(72) Inventors: Duy Nguyen, Bristow, VA (US); Vu Huy Tran, Ho Chi Minh City (VN)

(21) Appl. No.: 15/186,421

(22) Filed: Jun. 17, 2016

Related U.S. Application Data
(60) Provisional application No. 62/181,548, filed on Jun. 18, 2015.

(51) Int. Cl. G06Q 30/02; G06F 17/30

(52) U.S. Cl. CPC G06Q 30/0246; G06F 17/30899

(57) ABSTRACT

A method and apparatuses can include: crawling web sites including an advertiser web site and a publisher website; identifying a resource article from the websites, the resource article including a title, an image, and body content; generating a resource article topic model; identifying a current article being read by a user; generating a current article topic model for the current article; calculating a semantic score by measuring the similarity between the resource article topic model and the current article topic model; calculating a reader score based on a click history of the user and a browsing history of the user; calculating a traffic score based on a demographic relationship between the current article and the resource article; and recommending the resource article to the user based on the semantic score, the reader score, and the traffic score indicating the user will select the resource article.

### CROSS-REFERENCE TO RELATED APPLICATIONS

This claims priority benefit to all common subject matter of U.S. Provisional Patent Application 62/181,548 filed Jun. 18, 2015. The content of this application is incorporated herein by reference in its entirety.

### TECHNICAL FIELD

This disclosure relates to improvements to internet infrastructure efficiency, and more particularly to improvements in hardware utilization and efficiency for campaign generation, optimization, and targeting.

### BACKGROUND

Technologies supporting and underwriting the vast and globally interconnected network of the internet represent one of the largest areas for technological advancement and innovation. The internet not only represents the ability for individuals to connect across the globe but holds out the promise of quickly enlarging markets and consumer bases for established businesses and entrepreneurs alike.

With each passing day, the body of information content available on the Web is larger and more diversified in nature. Accompanying the explosive growth of the World Wide Web, for instance, is the ever increasing use of advertising material on practically any content which a user can access.

This large body of information can be problematic by reducing ability of users to meaningfully connect and requiring ever greater computing resources. In this environment, advertisers and businesses are forced to simply increase their budget when internet marketing campaigns are less than effective.

The current model connecting users over the internet places large amounts of irrelevant data before users rather than content relevant to each user at the time it is needed. The current model relies heavily on expansive and expensive computing overhead.

Solutions have been long sought but prior developments have not taught or suggested any complete solutions, and solutions to these problems have long eluded those skilled in the art. Thus there remains a considerable need for devices and methods that can decrease computing overhead, advertising budget requirements, and content irrelevancy.

### SUMMARY

A campaign optimization system and methods reducing computing overhead, reducing advertising budget requirements, improving content relevancy, and increasing computing efficiency are disclosed, which enable currently implemented hardware to perform with higher efficiency and more flexibility. The campaign system and methods can include: crawling internet websites including an advertiser website and a publisher website; identifying a resource article from the websites, the resource article including a title, an image, and body content; generating a resource article topic model of the body content of the resource article; identifying a current article being read by a user; generating a current article topic model for the current article; calculating a semantic score by measuring the similarity between the resource article topic model and the current article topic model; calculating a reader score based on a click history of the user and a browsing history of the user; calculating a traffic score based on a demographic relationship between the current article and the resource article; and recommending the resource article to the user based on the semantic score, the reader score, and the traffic score indicating the user will select the resource article.

Other contemplated embodiments can include objects, features, aspects, and advantages in addition to or in place of those mentioned above. These objects, features, aspects, and advantages of the embodiments will become more apparent from the following detailed description, along with the accompanying drawings.

### BRIEF DESCRIPTION OF THE DRAWINGS

The campaign system is illustrated in the figures of the accompanying drawings which are meant to be exemplary and not limiting, in which like reference numerals are intended to refer to like components, and in which:

FIG. 1 is a block diagram of a campaign system.

FIG. 2 is the deliverer block of FIG. 1.

FIG. 3 is a control flow for the article deliverer of FIG. 2.

FIG. 4 is a control flow for the campaign system of FIG. 1.

FIG. 5 is a block diagram of the collector block of FIG. 1.

FIG. 6 is a control flow for the matcher block and article builder of FIGS. 1 and 5, respectively.

FIG. 7 is a block diagram of the matcher block of FIG. 1.

FIG. 8 is a control flow for the trainer of FIG. 7.

FIG. 9 is a control flow for the index engine of FIG. 7.

FIG. 10 is a title control flow for the extract step of FIG. 6.

FIG. 11 is a body control flow for the extract step of FIG. 6.

FIG. 12 is a main image control flow for the extract step of FIG. 6.

### DETAILED DESCRIPTION

In the following description, reference is made to the accompanying drawings that form a part hereof, and in which are shown by way of illustration, embodiments in which the campaign system may be practiced. It is to be understood that other embodiments may be utilized and structural changes may be made without departing from the scope of the campaign system.

When features, aspects, or embodiments of the campaign system are described in terms of steps of a process, an operation, a control flow, or a flow chart, it is to be understood that the steps can be combined, performed in a different order, deleted, or include additional steps without departing from the campaign system as described herein.

The campaign system is described in sufficient detail to enable those skilled in the art to make and use the campaign system and provide numerous specific details to give a thorough understanding of the campaign system; however, it will be apparent that the campaign system may be practiced without these specific details.

In order to avoid obscuring the campaign system, some well-known system configurations are not disclosed in detail. Likewise, the drawings showing embodiments of the system are semi-diagrammatic and not to scale and, particularly, some of the dimensions are for the clarity of presentation and are shown greatly exaggerated in the drawing FIGS.

As used herein, the term system is defined as a device or method depending on the context in which it is used. When steps are described or when control flows having steps are described it will be appreciated that the steps can be combined, broken into smaller steps, or rearranged without departing from the scope of the campaign system.

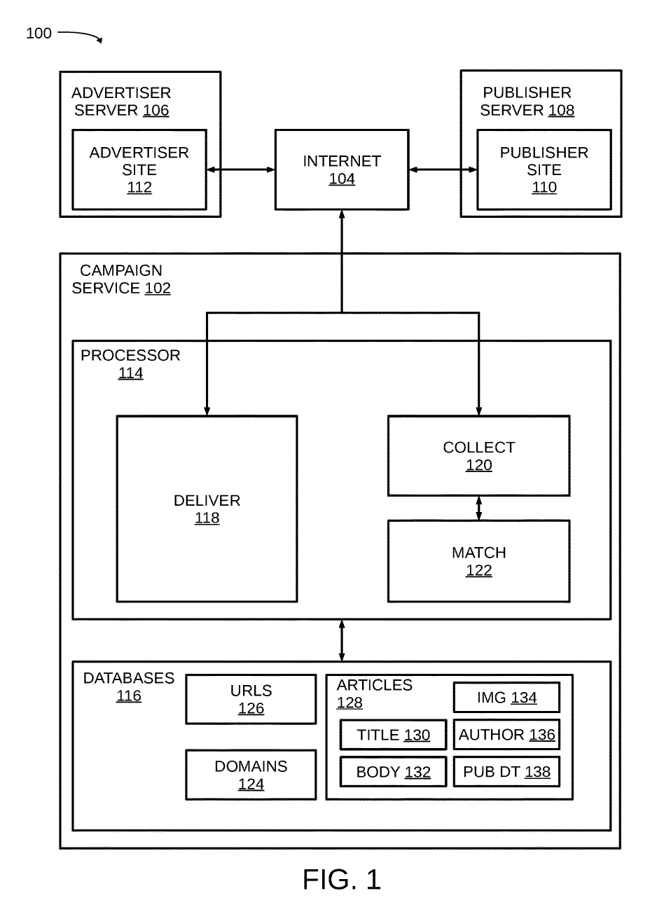

Referring now to FIG. 1 is a block diagram of a campaign system 100. The campaign system is depicted including campaign service architecture 102 communicatively coupled to a network. For expository purposes the network will be described as internet 104.

The internet 104 is further shown communicatively coupled to advertiser servers 106 and publisher servers 108. It is contemplated that the publisher servers 108 and the advertiser servers 106 can be the same or different servers and that the publisher servers 108 can host publisher websites 110 and that the advertiser servers 106 can host advertiser websites 112.

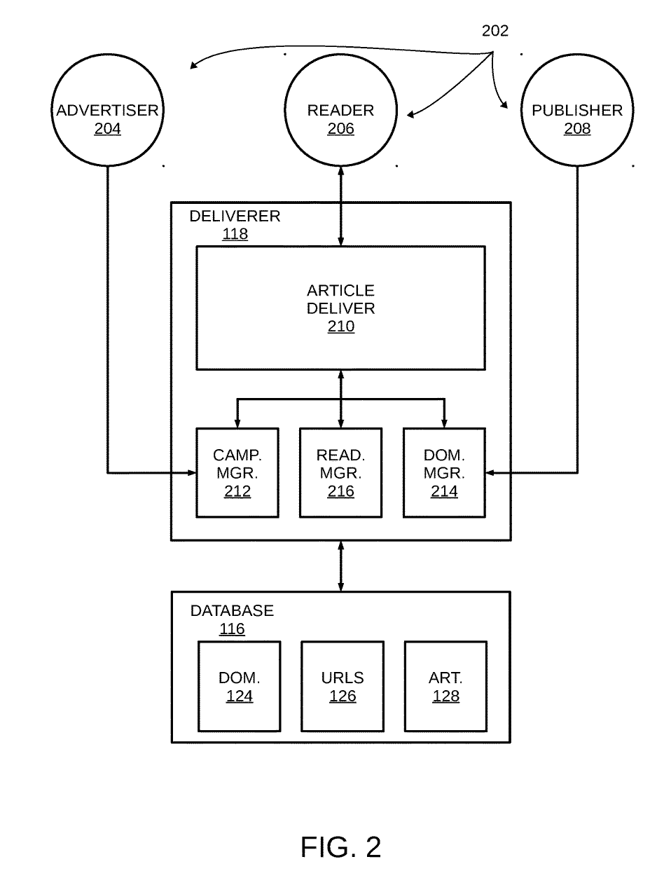

It is contemplated that the campaign service architecture 102 can extract data from the advertiser websites 112 and the publisher websites 110. The campaign service architecture 102 can then provide clean and formatted content targeted for each specific user 202 of FIG. 2.

The campaign service architecture 102 is depicted having processors 114 and databases 116. The processors 114 can be one or more computer processors implemented as embedded processors, microprocessors, hardware control logics, hardware finite state machines, or a combination thereof.

It is contemplated that the processors 114 can execute each step of the control flows as described herein for the campaign service architecture 102. It is contemplated that the processors 114 can execute the steps of the control flows for the campaign service architecture 102 either locally or as part of a distributed system.

The processors 114 can be configured to execute the control flow steps for the campaign service architecture 102. Further each component or sub-component of the campaign service architecture 102 as described herein can be implemented with the processors 114 and the processors can be configured to implement each component and sub-component of the campaign service architecture 102.

The databases 116 can be tangible non-transitory computer readable medium. Illustratively, the databases 116 can be implemented with random access memory, flash memory, disk storage, static random access memory, or a combination thereof. The databases 116 can be localized computer readable memory or can be part of a distributed system.

The databases 116 can be controlled by the processors 114 and can store all the data processed by the processors 114 within the steps of the control flows for the campaign service architecture 102. The processors 114 can further access data stored in the databases 116 and display the data on a display (not shown). As will be appreciated, the campaign service architecture 102 can transform raw data of the advertiser websites 112, the publisher websites 110, and the internet 104 usage histories of the users 202 into particular visual depictions of physical objects on the display of the users 202.

The processors 114 are depicted as including a deliverer block 118, a collector block 120, and a matcher block 122. The deliverer block 118, the collector block 120, and the matcher block 122 can be implemented on and execute all steps of each control flow for the deliverer block 118, the collector block 120, and the matcher block 122 with the processors 114.

The deliverer block 118 can be used to provide and display interfaces for the users 202. The collector block 120 can collect, retrieve, process, and extract data for display with the deliverer block 118. The matcher block 122 can determine content relevancy and relatedness to the users 202, which can then direct the deliverer block 118 to display specific related or connected content to the users 202.

The databases 116 can be shared databases and can store domains 124, URLs 126, and articles 128. The domains 124 can be the domains from the advertiser websites 112 and the publisher websites 110. The URLs 126 can be parsed from the domains 124.

The articles 128 can be “cleaned” articles that are crawled, preprocessed, formatted, and extracted from URLs 126. The articles 128 contain several fields that are useful for post-processing. Illustratively, the articles 128 are depicted having titles 130, bodies 132, main images 134, authors 136, and publication dates 138.

Referring now to FIG. 2 is the deliverer block 118 of FIG. 1. The deliverer block 118 is depicted having the users 202 communicatively coupled thereto.

The users 202 depicted can include advertisers 204, readers 206, and publishers 208. Each of the users 202 can interface with the deliverer block 118 in different ways allowing the deliverer block 118 to provide different content to different groups of the users 202.

Illustratively, the readers 206 can interface with the deliverer block 118 through an article deliverer 210. The article deliverer 210 can provide relevant articles 128 of FIG. 1 to the readers 206.

More particularly, the article deliverer 210 can render and deliver the articles 128 and recommendations for the articles 128. The article deliverer 210 can provide the articles 128 and the recommendations for the articles 128 based on the readers 206 making requests when the reader 206 browses the articles 128 on the advertiser websites 112 of FIG. 1, the publisher websites 110 of FIG. 1 or other webpages of the internet 104 of FIG. 1.

The advertisers 204 can interface with the deliverer block 118 through a campaign manager 212. The campaign manager 212 can provide data, statistics, and analytical tools.

More particularly, the campaign manager 212 can provide a graphical interface for the advertisers 204 enabling the advertisers 204 to manage their ad campaigns. The data, statistics, and analytical tools can include, budget management, time management, reports on various kinds of statistics. Specifically, the reports on various statistics can include amount of time the readers 206 spend viewing content, number of clicks the readers 206 make, social media exposure, and conversion rates.

The publishers 208 can interface with the deliverer block 118 through a domain manager 214. The domain manager 214 can provide the publishers 208 with information such as financial information, availabilities, and reports.

The article deliverer 210 can be coupled to a reader manager 216. The reader manager 216 can operate as an internal sub-component of the deliverer block 118 that is coupled to the article deliverer 210.

The reader manager 216 functions as a data source for factors that can be used by the article deliverer 210. The reader manager 216 can store the readers 206 online activities and histories that can be used by the article deliverer 210 to provide recommendations to the articles 128 or to provide the articles 128 themselves.

The processors 114 of FIG. 1 can execute steps of control flows, implementing the article deliverer 210, the campaign manager 212, and the domain manager 214. The reader manager 216 can be implemented and utilize the processors 114 to execute control flows for the reader manager 216.

The reader manager 216 can further utilize non-transitory computer readable medium to store the histories and the activities of the readers 206. The deliverer block 118 is depicted as coupled to the databases 116, which can directly provide the domains 124, the URLs 126, and the articles 128 to the deliverer block 118.

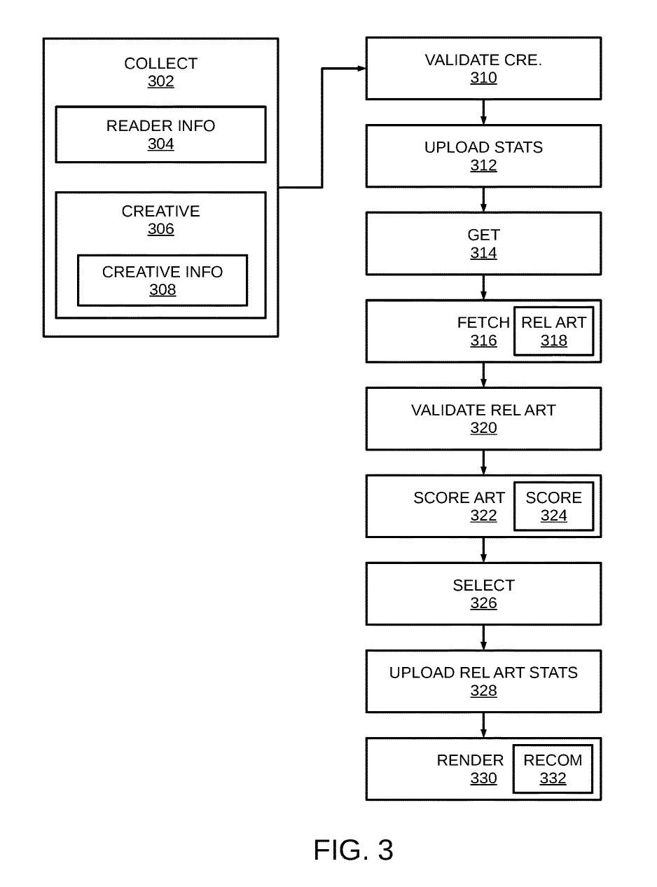

Referring now to FIG. 3, therein is shown a control flow for the article deliverer 210 of FIG. 2. The steps of the control flow can be executed by the processors 114 of FIG. 1. Further, data used by the steps of the control flow or resulting from the steps of the control flow can be stored in non-transitory computer readable medium, for example in the database 116 of FIG. 1.

The article deliverer 210 can begin with a collection of information in a collection step 302. The collection step 302 can collect reader information 304 about the reader 206 of FIG. 2 with a creative 306.

The reader information 304 can include information such as current page, current session, click histories and browsing histories. It is contemplated that the readers 206 entire click history can be collected and three days of the readers 206 browsing history.

The reader information 304 can be collected by the creative 306 as used herein means a piece of code for the publishers 208 to install into the publisher websites 110. The creative 306 collects the reader information 304 and makes requests to the deliverer block 118 of FIG. 1 for appropriate articles 128 of FIG. 1, which can be advertisements.

The collection step 302 can further collect creative information 308. The creative information 308 can include the position of the creative 306 relative to other components on the publisher websites 110, the transparency of the creative 306, and the number of creatives 306 used by the publisher websites 110.

Once the reader information 304 is collected by the creative 306 and the creative information 308 is collected, the article deliverer 210 can execute a creative validation step 310. During the creative validation step 310, the creative 306 can be validated.

The creative 306 can be considered valid by the article deliverer 210, for example, if where the creative 306 is placed doesn't cover other components of the publisher websites 110, the creative 306 is not being covered by other components of the publisher websites 110, the number of the creatives 306 used on the publisher website 110 is below a threshold, and when the creative's 306 transparency is below a percentage threshold.

The creative validation step 310 can validate the creative 306 by utilizing the processors 114 to render the publishers' website 110 and to calculate the width, the height, and the transparency of the creative 306 along with components near the creative 306 and determine whether there is any overlap and if so how much overlap there is.

In some contemplated embodiments, where components do overlap the creative 306 more than a threshold percentage—such as 10% or 15%—and the transparency of the creative 306 is greater than 0, the creative 306 can be considered invalid. Once the creative validation step 310 is executed, the article deliverer 210 can execute a creative statistics upload step 312.

The creative statistics upload step 312 can upload and record the analysis of the creative information 308 generated during the creative validation step 310 as well as uploading and recording the final determination of whether the creative 306 is valid or not.

Once the creative statistics upload step 312 is executed, the article deliverer 210 can execute a get content step 314. The get content step 314 can get the content from the databases 116 of FIG. 1 for the URL that the reader 206 is requesting. The content retrieved by the get content step 314 can include the main image 134 of FIG. 1, the body 132 of FIG. 1, the title 130 of FIG. 1, the publication date 138 of FIG. 1, and the author 136 of FIG. 1. The get content step 314 is also contemplated to render the content of the URL requested by the reader 206 on a display as the article 128 so that the reader 206 can consume the content.

Once the get content step 314 is executed, the article deliverer 210 can execute a fetch related step 316. The fetch related step 316 can collect related articles 318 from the databases 116. The related articles 318 can be articles 128 that are related to the article 128 requested initially by the reader 206.

Once the get content step 314 is executed the article deliverer 210 can execute a validate related article step 320. The validate related article step 320 can validate the related articles 318 fetched during the fetch related step 316.

The related articles 318 can be validated if the related articles' 318 HTML tag markup is well-formed. It is further contemplated that, the related articles 318 can be validated even if the HTML tag markup is not well-formed so long as the HTML tag markup errors can be recovered from.

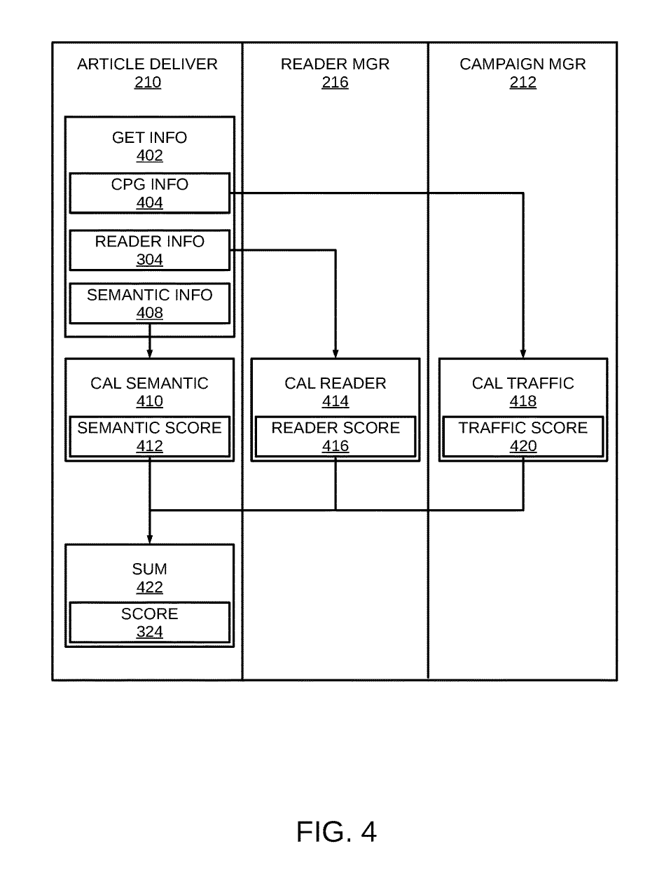

It is further contemplated that the related articles 318 can be validated only when, in addition to the HTML tag markup, the related articles 318 does not conflict with censored content such as pornographic content, illicit drug content, or violent content. Once the validate related article step 320 is executed the article deliverer 210, the reader manager 216 of FIG. 2, and the campaign manager 212 of FIG. 2 can score the related articles 318 in a score related article step 322 as discussed below with regard to FIG. 4. The score related article step 322 can result in scores 324 for the related articles 318.

Once the score related article step 322 is executed and the scores 324 are generated for the related articles 318, the article deliverer 210 can execute a related article selection step 326. The related article selection step 326 can select the related articles 318 with the highest scores 324. For example, the top three scoring related articles 318 can be selected.

Once the related article selection step 326 is executed, the article deliverer 210 can execute an upload related article statistics step 328. The upload related article statistics step 328 can record statistics to the databases 116.

Once the upload related article statistics step 328 has been executed, the article deliverer 210 can execute a render recommendations step 330. The render recommendations step 330 can display a rendered and formatted version of recommended articles 332, which can be visual symbols for the related articles 318 with the highest scores 324 as determined by the score related article step 322.

It is contemplated that the render recommendations step 330 can provide the recommended articles 332 as titles, thumbnails, summaries, or a combination thereof. The reader 206 can select one of the recommended articles 332 to initiate the retrieval of the article 128 during a later step.

Referring now to FIG. 4, therein is shown a control flow for the campaign system 100 of FIG. 1. The steps of the control flow can be executed by the processors 114 of FIG. 1. Further, data used by the steps of the control flow or resulting from the steps of the control flow can be stored in non-transitory computer readable medium, for example in the database 116 of FIG. 1.

The control flow depicts one exemplary method of creating the score 324 by utilizing the article deliverer 210, the reader manager 216, and the campaign manager 212. The article deliverer 210 can initiate the execution of the control flow by executing a get information step 402.

The get information step 402 can retrieve information about the users 202 of FIG. 2 and the articles 128 of FIG. 1. Specifically, the get information step 402 can get campaign information 404 about the advertiser 204 of FIG. 2, the reader information 304 about the reader 206 of FIG. 2, and semantic information 408 about the articles 128 of FIG. 1. The get information step 402 can get information from the databases 116 of FIG. 1.

The reader information 304 can be passed to the reader manager 216 either by the article deliverer 210 pushing the reader information 304 to the reader manager 216 or by the reader manager 216 executing a retrieval step to get the reader information 304 from the article deliverer 210. The campaign information 404 can be passed to the campaign manager 212 either by the article deliverer 210 pushing the campaign information 404 to the campaign manager 212 or by the campaign manager 212 executing a retrieval step to get the campaign information 404 from the article deliverer 210.

The article deliverer 210 can execute a calculate semantic score step 410. The calculate semantic score step 410 can produce a semantic score 412.

The calculate semantic score step 410 can produce the semantic score 412 by measuring the similarity between the texts of the article 128 and other articles 128. The relatedness of the articles 128 can be calculated utilizing techniques such as Latent Semantic Indexing.

The calculate semantic score step 410 can first construct a term-document matrix to reflect how important a word is within the articles 128. The term-document matrix can then be processed using Singular Value Decomposition, which reduces the size of the term-document matrix while preserving the similarity structure.

Latent Semantic Indexing can then be used to generate a topic model. The topic model can represent each of the articles 128. The topic models of the articles 128 can then be compared.

The topic models from each of the articles 128 can represent the articles 128 in vector space and can be compared by taking the cosine of the angle between the two vectors, or can be compared by the dot product between the normalizations of the two vectors. Values close to 1 represent very similar content while values close to 0 represent very dissimilar content.

Illustratively, the topic model of the article 128 the reader 206 is currently reading can be compared to other articles 128 to determine how closely the article 128 the reader 206 is currently reading is to other articles 128. The comparison between the article 128 the reader 206 is currently reading and the other articles 128 can be the semantic score 412 calculated by the calculate semantic score step 410.

The reader manager 216 can execute a calculate reader score step 414. The calculate reader score step 414 can produce a reader score 416.

The reader score 416 can be a score that reflects the likelihood of the reader 206 will select a specific article 128. The reader score 416 is calculated based on the reader information 304 including click histories and browsing histories of the reader 206.

Illustratively, if the reader 206 tends to click on articles 128 that have content largely about celebrities then the reader score 416 for that reader 206 to one of the articles 128 about celebrities is high. Following the same example, if the reader 206 has been browsing a prominently about technologies then the reader score 416 should be high for one of the articles 128 having a topic model directed towards technology.

It is contemplated that the calculate reader score step 414 can screen out some browsing histories, for example the calculate reader score step 414 can evaluate three days of browsing histories. Further it is contemplated that the calculate reader score step 414 can evaluate the entire scope of click histories retrievable for the reader 206.

The campaign manager 212 can execute a calculate traffic score step 418. The calculate traffic score step 418 can produce a traffic score 420.

The traffic score 420 can calculate the demographic relationship between the article 128 currently being read by the reader 206 and the other articles 128. It is contemplated that the calculation of the calculate traffic score step 418 can be restricted to the current article being read by the reader 206 and the articles 128 that have a highly related topic model as determined by the semantic score 412.

For example, the calculate traffic score step 418 can evaluate the distribution of traffic for the article 128 currently being read, such as 80% US readers, and 20% “other” readers. Continuing with this example, if the related article 318 has a similar demographic distribution, the traffic score 420 will be high, whereas if the related article 318 has a dissimilar distribution the traffic score 420 will be low.

It is contemplated that the traffic score 420 can be calculated based on a cosine distance to between two vectors of multiple dimensions. The two vectors can represent two of the articles 128 while the multidimensional values can represent the specific traffic from each country for the articles 128.

It is contemplated that the calculate semantic score step 410, the calculate reader score step 414, and the calculate traffic score step 418 can be executed serially, sequentially, in parallel, or a combination thereof. It is further contemplated that the retrieval of the reader information 304, and the campaign information 404 from the article deliverer 210; or additionally, the pushing of the reader information 304 to the reader manager 216 and the pushing of the campaign information 404 to the campaign manager 212 can be executed serially, sequentially, in parallel, or a combination thereof

The traffic score 420 and the reader score 416 can be returned to the article deliverer 210 either by being called by the article deliverer 210, by being pushed by the reader manager 216 and the campaign manager 212, or by a combination thereof. The reader score 416 and the traffic score 420 can be returned to the article deliverer 210 in parallel, or sequentially.

Once the traffic score 420 and the reader score 416 are returned to the article deliverer 210, the article deliverer 210 can execute a summation step 422. The summation step 422 can evaluate the semantic score 412, the traffic score 420, and the reader score 416 together with other coefficients to calculate the score 324.

The summation step 422 can evaluate the semantic score 412, the reader score 416, and the traffic score 420 utilizing Equation 1:

f(x,y,u)=a₁readerscore(x,u)+a₂trafficscore(x,y)+a₃semanticscore(x,y) (EQUATION 1)

where a₁, a₂, a₃ represent coefficients for balancing the semantic score 412, the traffic score 420, and the reader score 416. The variable x can refer to the content of a current article 128 being read by the reader 206. The variable y can refer to the content of other articles 128. The variable u can refer to a specific reader 206.

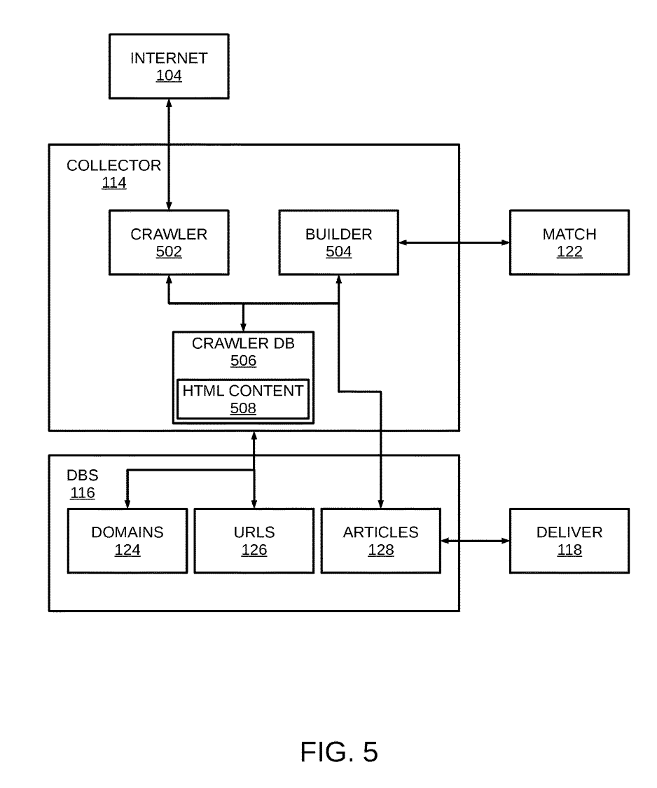

Referring now to FIG. 5, therein is shown a block diagram of the collector block 120 of FIG. 1. The collector block 120 is depicted having a page crawler 502 and an article builder 504, both communicatively coupled to a crawler database 506.

The page crawler 502 can access the publisher websites 110 and the advertiser websites 112 and extract information. The page crawler 502 can be directed to the advertiser websites 112 and the publisher websites 110, or to portions thereof, by the URLs 126 stored within the databases 116.

The page crawler 502 can crawl the HTML of the advertiser websites 112 and the publisher websites 110 and extract raw HTML content 510 from the publisher websites 110 and the advertiser websites 112. The HTML content 510 can be stored within the crawler database 506.

The article builder 504 can process the HTML content 510 extracting the body 132 of FIG. 1, the title 130 of FIG. 1, the author 136 of FIG. 1, the main image 134 of FIG. 1, and the publication date 138 of FIG. 1 for the article 128. The article builder 504 can extract clean and store the HTML the fields of the article 128 within the database 116.

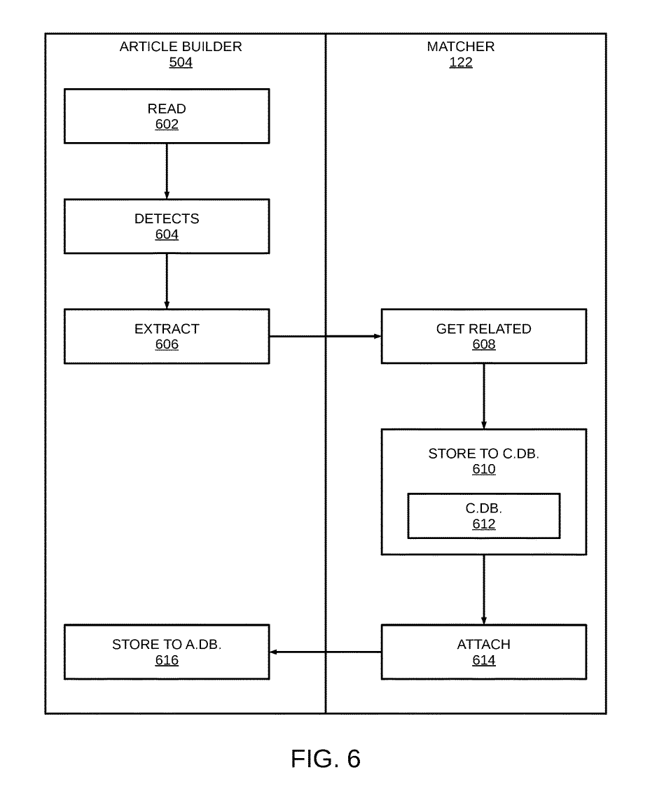

Referring now to FIG. 6, therein is shown a control flow for the matcher block 122 and article builder of FIGS. 1 and 5, respectively. The steps of the control flow can be executed by the processors 114 of FIG. 1. Further, data used by the steps of the control flow or resulting from the steps of the control flow can be stored in non-transitory computer readable medium, for example in the database 116 of FIG. 1.

The control flow can be initiated with the execution of a read step 602. The read step 602 can read the HTML content 510 of FIG. 5 from the crawler database 506 of FIG. 5. After the read step 602 the article builder 504 can execute a detect step 604.

The detect step 604 can determine whether the HTML content 510 collected by the page crawler 502 of FIG. 5 can be an article 128. The detect step 604 can determine that the HTML content 510 is an article 128 if the title 130, main image 134, and body 132 can be determined by the HTML tags from the HTML content 510.

Once the HTML content 510 is determined to be one of the articles 128, the article builder 504 can execute an extract step 606. The extract step 606 can be used to extract fields such as the title 130, the main image 134, the body 132, the author 136, and the publication date 138.

The article builder 504 can pass the fields to the matcher block 122. The matcher block 122 can then execute a get related step 608. The get related step 608 can determine which of the article 128 are semantically related to the article retrieved from the article builder 504.

Once the related articles 318 of FIG. 3 are determined, the matcher block 122 can store the article 128 retrieved from the article builder 504 as well as the related articles 318 to a content database 612 in a store to content database step 610. The content database 612 can store and index the related articles 318. Once the related articles 318 are determined during the get related step 608 and stored during the store to content database step 610, the matcher block 122 can attach the related articles 318 to the article 128 retrieved by the article builder 504 by executing an attachment step 614.

The article 128 and the related articles 318 can be attached with a reference or a link. The matcher block 122 can pass the information regarding the related articles 318 attached to the article 128 back to the article builder 504 and the article builder 504 can store the article 128 and the attached related articles 318 to the database 116, which can store all of the articles 128, in a store to database step 616.

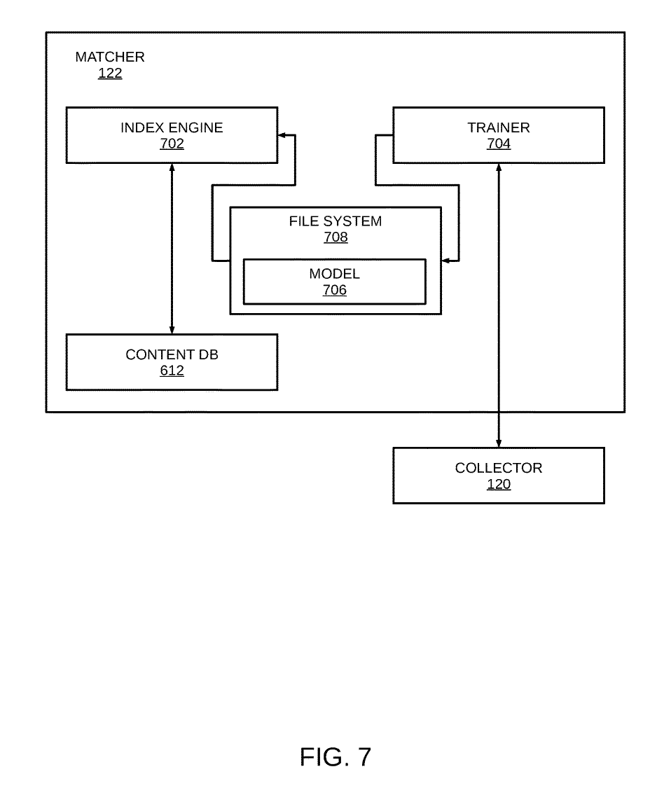

Referring now to FIG. 7, therein is shown a block diagram of the matcher block 122 of FIG. 1. The matcher block 122 is depicted having an index engine 702. The index engine 702 can determine which of the articles 128 of FIG. 1 is semantically related to an article 128 during the get related step 608 of FIG. 6.

The index engine 702 can also index the content database 612 as a scheduled task, for example the index engine 702 can index the articles 128 every 20 minutes. The matcher block 122 can further include a trainer 704. The trainer 704 can generate the topic models 706 as described above with regard to FIG. 4. The topic models 706 can be used to determine the degree of semantic relationship between the articles 128.

The trainer 704 can store the topic models 706 within a file system 708. The index engine 702 can retrieve the topic models 706 from the file system 708 for utilization in determining the extent of semantic relationship between the articles 128.

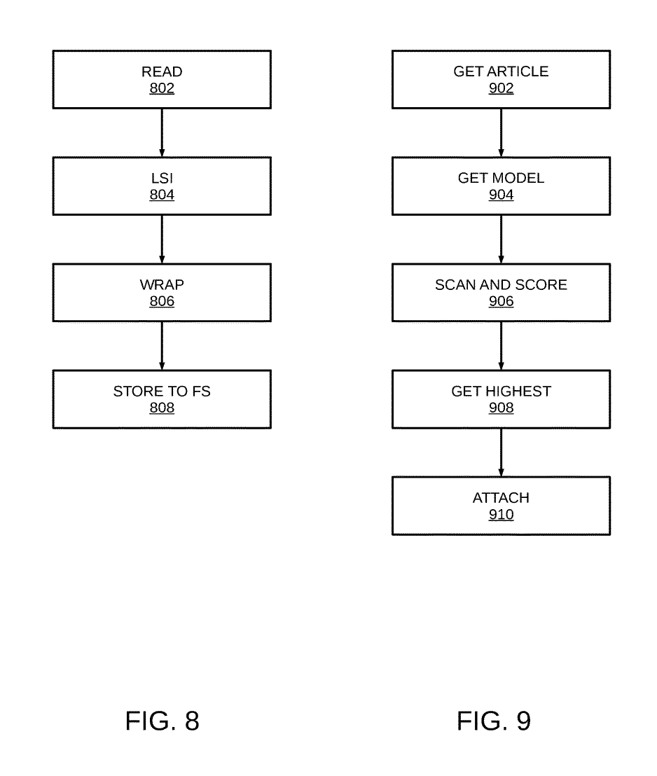

Referring now to FIG. 8, therein is shown a control flow for the trainer 704 of FIG. 7. The steps of the control flow can be executed by the processors 114 of FIG. 1. Further, data used by the steps of the control flow or resulting from the steps of the control flow can be stored in non-transitory computer readable medium, for example in the database 116 of FIG. 1.

The control flow for the trainer 704 can begin by executing a read step 802. The read step 802 can read the content of the article 128 of FIG. 1 from the file system 708 of FIG. 7 or from the content database 612 of FIG. 6.

The content of the article 128, which can be contained within the body 132 of FIG. 1, can be evaluated during an LSI step 804. The LSI step 804 can first construct a term-document matrix to reflect how important a word is within the articles 128. The term-document matrix can then be processed using Singular Value Decomposition, which reduces the size of the term-document matrix while preserving the similarity structure.

Latent Semantic Indexing can then be used to construct a configuration of the article 128 in a latent 2-D space. That is, two topics are contemplated and therefore a 2-D configuration. The words contributing the most to one topic will be considered as the main topic while all other words will be considered the second topic.

Once the 2-D configuration of the article 128 is determined, a wrap step 808 can be executed to wrap up the configuration of the article 128 with the topic model 706 as a vector two dimensional vector. The topic models 706 for the articles 128 can then be saved to the file system 708 in a save step 810.

Referring now to FIG. 9, therein is shown a control flow for the index engine of FIG. 7. The steps of the control flow can be executed by the processors 114 of FIG. 1. Further, data used by the steps of the control flow or resulting from the steps of the control flow can be stored in non-transitory computer readable medium, for example in the database 116 of FIG. 1.

The index engine 702 can first execute a get article step 902. The get article step 902 can retrieve the article from the content database 612 of FIG. 6. The index engine 702 can also execute a get model step 904.

The get model step 904 can retrieve the topic models 706 of FIG. 7 from the file system 708 of FIG. 7. Once the topic models 706 is retrieved, the index engine 702 can execute a scan and score step 906.

The index engine 702 can scan and score all of the other articles 128 based on the topic model 706 for each article 128 saved in the file system 708. The topic models 706 from each of the articles 128 can represent the articles 128 in vector space and can be compared by the index engine 702 during the scan and score step 906 by taking the cosine of the angle between two vectors.

Alternatively, it is contemplated that the index engine 702 can compare the topic models 706 of each of the articles 128 with the dot product between the normalizations of the two vectors. Values close to 1 represent very similar content while values close to 0 represent very dissimilar content.

Once the articles 128 with the highest similarity to the article 128 retrieved during the get article step 902 are found, the index engine 702 can execute a get highest step 908 during which the articles 128 with the highest similarities (the related articles 318) are retrieved. The index engine 702 can then execute an attach step 910. The attach step 910 can attach the related articles 318 to the article 128 retrieved during the get article step 902.

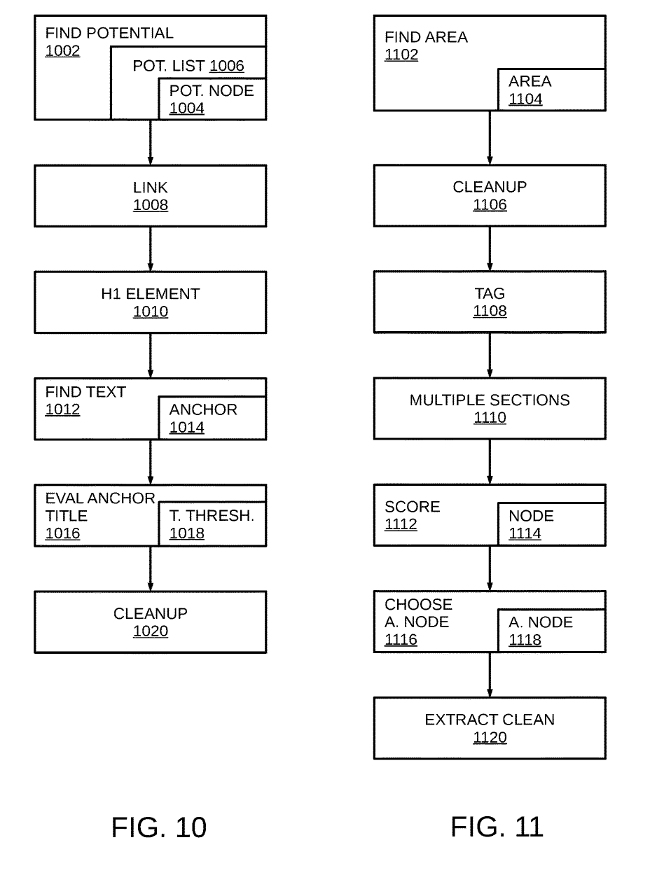

Referring now to FIG. 10, therein is shown a title control flow for the extract step of FIG. 6. The steps of the control flow can be executed by the processors 114 of FIG. 1. Further, data used by the steps of the control flow or resulting from the steps of the control flow can be stored in non-transitory computer readable medium, for example in the database 116 of FIG. 1.

The article builder 504 can initiate the title control flow by executing a find all potential nodes step 1002. The find all potential nodes step 1002 can find potential nodes 1004 within the article 128 of FIG. 1 by executing an ordered list of regular expressions against the article 128.

The potential nodes 1004 can be a string of text and can further include links. The ordered list of regular expressions, can be used for example, to search and identify a short, emphasized text line placed on the top of the article as a potential node 1004.

The potential nodes 1004 can be placed into a potential node list 1006. The potential node list 1006 can be filtered during the find all potential nodes step 1002.

For example, the potential node list 1006 can be filtered by deleting duplicates of the potential nodes 1004 and by deleting the potential nodes 1004 from the potential node list 1006 with empty texts.

Once the potential nodes 1004 have been identified, placed within the potential node list 1006, and filtered during the find all potential nodes step 1002, the article builder 504 can execute a link removal step 1008. The link removal step 1008 can perform three filtering procedures by stepping through each potential node 1004 within the potential node list 1006.

First, the link removal step 1008 can remove links from each of the potential nodes 1004 within the potential node list 1006 when the potential node 1004 includes both links and text. In this first situation, when the potential nodes 1004 includes both links and text, the content of the links will also be removed from the potential nodes 1004.

Second, when the potential node 1004 is exactly a link, the link removal step 1008 can check the link's referring location. If the link's referring location is the current page, or the page where the link resides, the potential node 1004 is immediately chosen as the title 130 of FIG. 1 and the title control flow ends.

Third, when the potential node 1004 is exactly a link, the link removal step 1008 can check the link's referring location. If the link's referring location is not the current page, or the page where the link resides, the potential node 1004 is deleted from the potential node list 1006 and the subsequent potential nodes 1004 are evaluated by the link removal step 1008.

Once the link removal step 1008 has been completed the article builder 504 can execute an h₁ element determination step 1010. The h₁ element determination step 1010 can scan through the potential node list 1006 and determine whether any of the potential nodes 1004 is tagged as an h₁ element. If exactly and only one of the potential nodes 1004 is identified as an h₁ element, the potential node 1004 is immediately chosen as the title 130 and the title control flow ends.

When there are more or less than one h₁ element, the h₁ element determination step 1010 ends and the article builder 504 can execute a find text step 1012. The find text step 1012 can scan the article 128 and identify text from two places within the article 128.

The first place the find text step 1012 can identify text is identifying open graph meta tags within the article 128, such as text tagged as “og:title”. The second place the find text step 1012 can identify text is by identifying an HTML <title>tag within the HTML <head>.

When the find text step 1012 identifies text tagged as og:title, the find text step 1012 will set an anchor title 1014 to the text tagged as og:title. When text within the article 128 is not found with the og:title meta tag, the anchor title 1014 is set to the text having the HTML tag <title>within the <head>of the article 128.

If no text is found within the article 128 that is tagged with the open graph meta tag or the HTML tag, the find text step 1012 can end. Once the find text step 1012 is complete the article builder 504 can execute an evaluate anchor title step 1016.

The evaluate anchor title step 1016 can determine whether the anchor title 1014 can be found within the article 128. When the anchor title 1014 is not found within the article 128, the evaluate anchor title step 1016 can choose the highest ranking potential node 1004.

It is contemplated that when the potential node list 1006 is ordered by rank or priority, the evaluate anchor title step 1016 will choose the first potential node 1004. When the anchor title 1014 is identified within the article 128, the evaluate anchor title step 1016 will iterate through all of the potential nodes 1004 and assess the similarity of the potential nodes 1004 to the anchor title 1014.

The similarities between the potential nodes 1004 and the anchor title 1014 are determined by counting common or similar words between each of the potential nodes 1004 and the anchor title 1014. The evaluate anchor title step 1016 can then choose the potential node 1004 with the highest similarity to the anchor title 1014.

If the potential node 1004 with the highest similarity is equal to or greater than a title threshold 1018, the potential node 1004 with the highest similarity is chosen as the title 130. When the potential node 1004 with the highest similarity is less than the title threshold 1018, then the anchor title 1014 is chosen as the title 130.

Once the title 130 is identified by any of the steps within the title control flow, the article builder 504 can execute a title clean up step 1020. The title clean up step 1020 can remove any domains, site names, categories, or a combination there of from the title 130. For example, if the title 130 is identified as: “title name—CNN.com” the title clean up step 1020 can remove portions of the title 130 to produce a clean title such as: “title name”.

Referring now to FIG. 11, therein is shown a body control flow for the extract step of FIG. 6. The steps of the control flow can be executed by the processors 114 of FIG. 1. Further, data used by the steps of the control flow or resulting from the steps of the control flow can be stored in non-transitory computer readable medium, for example in the database 116 of FIG. 1.

The body control flow can be used to identify the body 132 of FIG. 1. The body 132 can be cleaned text content from the whole article, after discarding titles, subtitles, external links, images, captions, ads, and recommendations.

The article builder 504 can initiate the body control flow by executing a find potential areas step 1102. The find potential areas step 1102 can find areas 1104 which potentially contain the content of the body 132 for the article 128 of FIG. 1.

The areas 1104 within the article 128 can be identified by executing an ordered list of regular expressions against the article 128. It is contemplated that when the regular expressions do not return the areas 1104, the find potential areas step 1102 can search for the body 132 in the document root, or alternatively the document root can be used as the areas 1104.

Once the areas 1104 have been identified, the article builder 504 can execute an area clean up step 1106. The area clean up step 1106 can remove portions of the areas 1104, such as: link clusters, junk texts, titles, comments, and others.

Once the areas 1104 have been cleaned in the area clean up step 1106, the article builder 504 can execute a paragraph tag step 1108. The paragraph tag step 1108 can replace HTML elements for the areas 1104 containing useful text with a p element defining a paragraph.

It is contemplated that when an HTML element contains both useful and useless texts in a very complicated hierarchy, the paragraph tag step 1108 flatten that element and transform it into a simple paragraph element containing useful content only. After the areas 1104 have been tagged in the paragraph tag step 1108, the article builder 504 can execute a multiple sections step 1110.

The multiple sections step 1110 can detect whether the article 128 contains multiple sections. If the article 128 does contain multiple sections, the multiple sections step 1110 will merge the sections. If the multiple sections step 1110 does not detect multiple sections, the multiple sections step 1110 will end.

Once the multiple sections step 1110 is complete, the article builder 504 can execute a score step 1112. The score step 1112 can score each node 1114 remaining after the multiple sections step 1110.

The node 1114 can include text strings within the areas 1104. The nodes 1114 within the areas 1104 can be scored based on the node's 1114 structures, such as the node's 1114 children and siblings in an HTML tree. The nodes 1114 within the areas 1104 can further be scored based on text length, number of line breaks, text density, and link density.

Further the score step 1112 can score the elements within the areas 1104 based on their structures, such as the element's children and siblings in an HTML tree. The elements within the areas 1104 can further be scored based on text length, number of line breaks, text density, and link density.

Once the nodes 1114 and elements are scored, the article builder 504 can execute a choose article node step 1116. When there is only one area 1104, the choose article node step 1116 can identify the highest scored element an article node 1118.

When the article 128 includes multiple areas 1104 as identified in the find potential areas step 1102, the node 1114 with the highest overall score from the score step 1112 will be identified as the article node 1118. Once the article node 1118 is identified, the article builder 504 can execute an extract clean content step 1120.

During the extract clean content step 1120, the article builder 504 can inspect the article node 1118 to calibrate and score children of the article node 1118. The article builder 504 will then extract clean content from the article node 1118, which can be identified as the body 132.

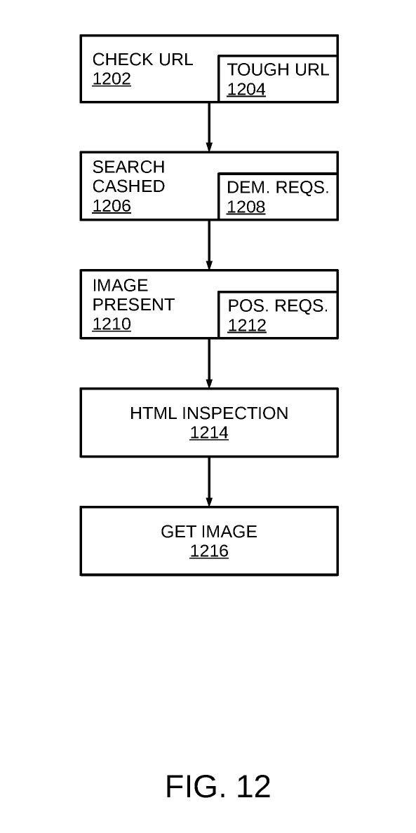

Referring now to FIG. 12, therein is shown a main image control flow for the extract step of FIG. 6. The steps of the control flow can be executed by the processors 114 of FIG. 1. Further, data used by the steps of the control flow or resulting from the steps of the control flow can be stored in non-transitory computer readable medium, for example in the database 116 of FIG. 1.

The main image control flow can be used to identify the main image 134 of FIG. 1. The main image 134 can be an image placed within the boundary of the article 128 of FIG. 1 with relevant content to the topic of the article 128.

It is contemplated that advertisement images and recommendation images can be ignored. In one contemplated embodiment the collector block 120 of FIG. 1, when implementing the article builder 504 of FIG. 5, can extract only a single main image 134 per article 128 and that the main image 134 can be chosen from good images.

It is contemplated that the main image 134 can have considerable size and preferably placed in a high relative position to the article 128, such as a cover image. It is further contemplated that when the article builder 504 is unable to detect the main image 134 placed inside the article 128, the article builder 504 can evaluate and consider open-graph images for the main image 134.

The article builder 504 can initiate the main image control flow by executing a check domain step 1202. The check domain step 1202 can check if the URL 126 of FIG. 1 of the target article 128 on the internet 104 of FIG. 1 is in a tough domain list 1204.

The tough domain list 1204 can be a list internally generated and maintained by the campaign system 100 of FIG. 1 or alternatively, the tough domain list 1204 can be a list provided by a third party. The tough domain list 1204 can be a list of the URLs 126 that present no ideal way of extracting the main images 134.

When the URLs 126 are determined to be in the tough domain list 1204, the article builder 504 will attempt to get the main image 134 from static places on the page. For example, the static places can include: data tagged with the meta property of open graph image “og:image”, or hardcoded selector.

Once the article builder 504 performs the check domain step 1202, the article builder 504 can execute a search cashed step 1206. The search cashed step 1206 can be executed because if previously there are processed URLs on the same domain with current URL, their paths will be “cached”.

The search cashed step 1206 can search for images in those cached paths on the current page and return the first cashed path which meets dimension requirements 1208.

The dimension requirements 1208 can include size thresholds for screening images and detecting acceptable images. The article builder 504 can further execute an image present step 1210.

The image present step 1210 can execute two sub-steps when vision data is detected during the search cashed step 1206. First, the image present step 1210 can search for any image paths that are meet positional requirements 1212.

The positional requirements 1212 can be thresholds for the position of an image with respect to the article 128. For example, an image path returned during the search cashed step 1206 can be filtered by the positional requirements 1212 based on whether the image is considered on the top portion of the article 128 or inside of the body 132 of FIG. 1 of the article 128.

The second sub-step the image present step 1210 can perform choosing the image path returned during the search cashed step 1206 that meets both the dimension requirements 1208 and the positional requirements 1212 as the main image 134 and the main image control flow will terminate. If no image is found that meets both the dimension requirements 1208 and the positional requirements 1212, the image present step 1210 can search for all images in paths being considered on the left side, the right side or the bottom side of the body 132 of the article 128.

The image paths found during the image present step 1210 that are considered on the left side, the right side or the bottom side of the body 132 of the article 128 can then be removed from consideration as a potential image for the main image 134. When the main image 134 is not determined by the image present step 1210, the article builder 504 can execute an HTML inspection step 1214.

The HTML inspection step 1214 can find all HTML image elements, “<img>”, under the top HTML node. Once the HTML image elements are returned, the HTML inspection step 1214 can filter the images with the dimension requirements 1208.

For example, the HTML inspection step 1214 can select all the HTML image elements that have a minimum dimension of 320×240 display resolution, and a width to height ratio between 0.5*320×240 and 2.0*320×240. Further the HTML inspection step 1214 can filter out any of the HTML image elements that look like author images or related articles thumbnails.

The HTML inspection step 1214 can then score the HTML image elements based on how big they are and how close the HTML image element's aspect ratio is to 320×240. The highest scored image can then be chosen and the image's path cashed for later use. Once the image is chosen in the HTML inspection step 1214, the article builder 504 can execute a get image step 1216. The get image step 1216 can retrieve the image from the og:image.

Thus, it has been discovered that the campaign system furnishes important and heretofore unknown and unavailable solutions, capabilities, and functional aspects. The resulting configurations are straightforward, cost-effective, uncomplicated, highly versatile, accurate, sensitive, and effective, and can be implemented by adapting known components for ready, efficient, and economical manufacturing, application, and utilization.

While the campaign system has been described in conjunction with a specific best mode, it is to be understood that many alternatives, modifications, and variations will be apparent to those skilled in the art in light of the preceding description. Accordingly, it is intended to embrace all such alternatives, modifications, and variations, which fall within the scope of the included claims. All matters set forth herein or shown in the accompanying drawings are to be interpreted in an illustrative and non-limiting sense.

Notably, the campaign service architecture, including the deliverer block, the matcher block, the collector block, each of their sub-components, and the databases, has been discovered to provide multiple improvements to the backend technologies enabling internet connectivity. These improvements result directly from the highly discriminating extraction techniques of the collector block, the accurate and highly inclusive matching techniques of the matcher block, the uniform delivery of the deliverer block, and their combination. As such, storage requirements, processing overhead, delay times, click-conversion rates, and reader consumption times are significantly improved.

What is claimed is:

1. A method of campaign optimization comprising:
crawling internet websites including an advertiser website and a publisher website;
identifying a resource article from the websites, the resource article including a title, an image, and body content;
generating a resource article topic model of the body content of the resource article;
identifying a current article being read by a user;
generating a current article topic model for the current article;
calculating a semantic score by measuring the similarity between the resource article topic model and the current article topic model;
calculating a reader score based on a click history of the user and a browsing history of the user;
calculating a traffic score based on a demographic relationship between the current article and the resource article; and
recommending the resource article to the user based on the semantic score, the reader score, and the traffic score indicating the user will select the resource article.

2. The method of claim 1 wherein generating the resource article topic model of the body content of the resource article includes generating a main topic model for identifying the main topic of the resource article and generating a secondary topic model for all other words within the body content of the resource article.

3. The method of claim 1 further comprising extracting the image from the websites based on the image being larger than a size threshold and the image being positioned at a top of the resource article or within the resource article.

4. The method of claim 1 further comprising extracting the body content based on identifying an article node from an area having a text length, a number of line breaks, a text density, and a link density larger than surrounding areas.

5. The method of claim 1 further comprising extracting the title based on identifying a potential node equal to or greater than a title threshold.

6. The method of claim 1 further comprising:
comparing the resource article to a stored article; and
attaching the stored article to the resource article when the stored article and the resource article are semantically related.

7. The method of claim 1 wherein calculating a semantic score by measuring the similarity between the resource article topic model and the current article topic model includes calculating the cosine of an angle between a resource article vector and a current article vector, or calculating a dot product between normalizations of the resource article vector and the current article vector, the resource article vector representing the resource article topic model and the current article vector representing the current article topic model.

8. A non-transitory computer readable medium, useful in association with a processor, including instructions configured to:
crawl internet web sites including an advertiser web site and a publisher web site;
identify a resource article from the websites, the resource article including a title, an image, and body content;
generate a resource article topic model of the body content of the resource article;
identify a current article read by a user;
generate a current article topic model for the current article;
calculate a semantic score by measuring the similarity between the resource article topic model and the current article topic model;
calculate a reader score based on a click history of the user and a browsing history of the user;
calculate a traffic score based on a demographic relationship between the current article and the resource article; and
recommend the resource article to the user based on the semantic score, the reader score, and the traffic score indicating the user will select the resource article.

9. The computer readable medium of claim 8 wherein the instructions configured to generate the resource article topic model of the body content of the resource article includes instructions configured to generate a main topic model for identifying the main topic of the resource article and generate a secondary topic model for all other words within the body content of the resource article.

10. The computer readable medium of claim 8 further comprising instructions configured to extract the image from the websites based on the image being larger than a size threshold and the image being positioned at a top of the resource article or within the resource article.

11. The computer readable medium of claim 8 further comprising instructions configured to extract the body content based on identification of an article node from an area having a text length, a number of line breaks, a text density, and a link density larger than surrounding areas.

12. The computer readable medium of claim 8 further comprising instructions configured to extract the title based on an identification of a potential node equal to or greater than a title threshold.

13. The computer readable medium of claim 8 further comprising instructions configured to:
compare the resource article to a stored article; and
attach the stored article to the resource article when the stored article and the resource article are semantically related.

14. The computer readable medium of claim 8 wherein the instructions configured to calculate a semantic score by measuring the similarity between the resource article topic model and the current article topic model includes instructions configured to calculate the cosine of an angle between a resource article vector and a current article vector, or to calculate a dot product between normalizations of the resource article vector and the current article vector, the resource article vector representing the resource article topic model and the current article vector representing the current article topic model.

15. A system for campaign optimization comprising:
a processor configured to:
crawl internet web sites including an advertiser web site and a publisher web site;
identify a resource article from the websites, the resource article including a title, an image, and body content;
generate a resource article topic model of the body content of the resource article;
identify a current article read by a user;
generate a current article topic model for the current article;
calculate a semantic score by measuring the similarity between the resource article topic model and the current article topic model;
calculate a reader score based on a click history of the user and a browsing history of the user;
calculate a traffic score based on a demographic relationship between the current article and the resource article; and
recommend the resource article to the user based on the semantic score, the reader score, and the traffic score indicating the user will select the resource article; and
a display configured to display the resource article to the user.

16. The system of claim 15 wherein the processor is configured to generate a main topic model for identifying the main topic of the resource article and generate a secondary topic model for all other words within the body content of the resource article.

17. The system of claim 15 wherein the processor is configured to extract the image from the websites based on the image being larger than a size threshold and the image being positioned at a top of the resource article or within the resource article.

18. The system of claim 15 wherein the processor is configured to extract the body content based on identification of an article node from an area having a text length, a number of line breaks, a text density, and a link density larger than surrounding areas.

19. The system of claim 15 wherein the processor is configured to:
compare the resource article to a stored article; and
attach the stored article to the resource article when the stored article and the resource article are semantically related.

20. The system of claim 15 wherein the processor is configured to calculate the cosine of an angle between a resource article vector and a current article vector, or to calculate a dot product between normalizations of the resource article vector and the current article vector, the resource article vector representing the resource article topic model and the current article vector representing the current article topic model.
